(19) United States
(12) Patent Application Publication
(10) Pub. No.: US 2025/0237867 A1
(43) Pub. Date: Jul. 24, 2025

(54) WAVEGUIDE ARRANGEMENT

(71) Applicant: DISPELIX OY, Espoo (FI)

(72) Inventor: Kasimir BLOMSTEDT, Espoo (FI)

(73) Assignee: DISPELIX OY, Espoo (FI)

(21) Appl. No.: 18/699,243

(22) PCT Filed: Sep. 8, 2022
(86) PCT No.: PCT/FI2022/050600

§ 371 Date: Apr. 5, 2024

(30) Foreign Application Priority Data
Oct. 8, 2021 (FI) 20216042

(51) Int. Cl. G02B 27/01

(52) U.S. Cl. CPC G02B 27/0172; G02B 2027/0112

(57) ABSTRACT

According to an example aspect of the present invention, there is provided an optical waveguide arrangement comprising an optical system configured to generate a configurable image encoded in a lightfield, at least one optical waveguide, arranged to receive light from the light field and to convey the light to plural locations in the optical waveguide for release, generating a waveguide-based display, the optical system comprises a light source with wavelength λ₁, wherein the optical waveguide, comprises a notch filter element with a stop-band at wavelength λ₁′, disposed on an outer surface of the optical waveguide to prevent leakage of light from the light field, wherein the stop-band at wavelength λ₁′ filters light of wavelength λ₁ incident on the notch filter element at a first angle of incidence.

### FIELD

The present disclosure relates to managing coloured light using optical waveguides.

### BACKGROUND

Optical waveguides are capable of conveying optical frequency light. Optical, or visible, frequencies refer to light with a wavelength of about 400-700 nanometres. Optical waveguides have been employed in displays, wherein light from a primary display may be conveyed using one or more waveguides to suitable locations for release for a user's eye or eyes.

Optical waveguide type displays may be worn in head-mounted glasses or helmets, and may be suitable for augmented reality or virtual reality type applications. In augmented reality, a user sees a view of the real world and superimposed thereon supplementary indications. In virtual reality, the user is deprived of his view into the real world and provided instead a view into a software-defined scene.

### SUMMARY

According to some aspects, there is provided the subject-matter of the independent claims. Some embodiments are defined in the dependent claims.

According to a first aspect of the present disclosure, there is provided an optical waveguide arrangement comprising an optical system configured to generate a configurable image encoded in a light field, at least one optical waveguide, arranged to receive light from the light field and to convey the light to plural locations in the optical waveguide for release, generating a waveguide-based display, the optical system comprises a light source with wavelength λ₁, wherein the optical waveguide, comprises a notch filter element with a stop-band at wavelength λ₁′, disposed on an outer surface of the optical waveguide to prevent leakage of light from the light field, wherein the stop-band at wavelength λ₁′ filters light of wavelength λ₁ incident on the notch filter element at a first angle of incidence.

According to a second aspect of the present disclosure, there is provided a method, comprising operating an optical waveguide arrangement comprising generating, using an optical system, a configurable image encoded in a light field, receiving light from the light field into at least one optical waveguide and conveying the light to plural locations in the optical waveguide for release, generating a waveguide-based display, wherein the optical system comprises a light source with wavelength λ₁, wherein the optical waveguide, has a notch filter element with a stop-band at wavelength λ₁′, disposed on an outer surface of the optical waveguide to prevent leakage of light from the light field, wherein the stop-band at wavelength λ₁′ filters light of wavelength λ₁ incident on the notch filter element at a first angle of incidence.

According to a third aspect of the present disclosure, there is provided a non-transitory computer readable medium having stored thereon a set of computer readable instructions that, when executed by at least one processor, cause an apparatus to at least generate, using an optical system, a configurable image encoded in a light field, convey light from the light field into at least one optical waveguide which is arranged to receive and to convey the light to plural locations in the optical waveguide for release, generating a waveguide-based display, the optical system comprising a light source with wavelength λ₁, wherein the optical waveguide has a notch filter element with a stop-band at wavelength λ₁′, disposed on an outer surface of the optical waveguide to prevent leakage of light from the light field, wherein the stop-band at wavelength λ₁′ filters light of wavelength λ₁ incident on the notch filter element at a first angle of incidence.

According to a fourth aspect of the present disclosure, there is provided a computer program configured to cause a method in accordance with the second aspect to be performed.

### BRIEF DESCRIPTION OF THE DRAWINGS

FIG. 1 illustrates an example system in accordance with at least some embodiments of the present invention;

FIGS. 2A and 2B illustrate an example system in accordance with at least some embodiments of the present invention;

FIGS. 3A and 3B illustrate spectrum and transmittance graphs of light sources and filters of an example system in accordance with at least some embodiments of the present invention;

FIG. 4 illustrates an example apparatus capable of supporting at least some embodiments of the present invention, and

FIG. 5 illustrates flowchart of a method in accordance with at least some embodiments of the present invention.

### EMBODIMENTS

By using light sources, such as lasers or light emitting diodes, LEDs, an enhanced waveguide-based display may be constructed, as will be described herein below. In detail, using more than one visible light wavelength to generate a single colour on a waveguide based display, colours may be rendered across the waveguide based display by mixing the colours appropriately. It might be also desirable, that only the user sees the image on the waveguide display and also that as little light as possible therefrom leaks to the outside world. In normal waveguide displays the display leaks light through the outer surface of the waveguide display. With some embodiments of the invention this leaking may be decreased or even almost totally eliminated by employing a notch filter layer applied over the outer surface of the waveguide display, as will be described herein below.

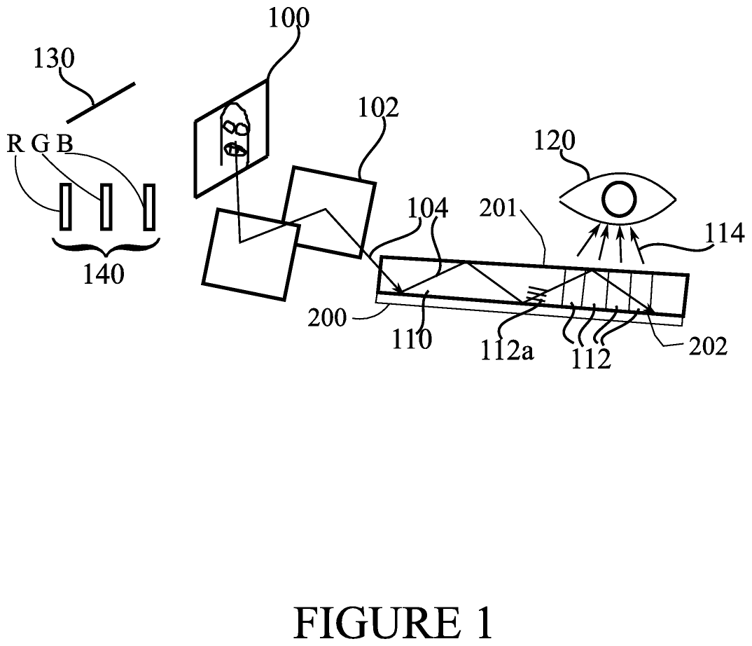

FIG. 1 illustrates an example system in accordance with at least some embodiments of the present invention. The system comprises light sources 140, in this case three light sources, R, G and B. In some embodiments, the system may comprise 1-4 light sources. The light sources may comprise laser or LED light sources, for example, wherein laser sources have the advantage that they are more strictly monochromatic than LEDs. Light sources 140 together with optional mirror 130 are configured to generate a light field in angular space which is usable in causing the waveguide display to generate its image. The image is encoded in the light field. The light field is schematically illustrated in FIG. 1 as field 100. In some embodiments, a physical primary display may display an image of the light field, while in other embodiments the system comprises no physical primary display and the image is merely encoded in the light field which is distributed in angular space. Light 104 from the light field 100 may be conveyed, directly or by using optical guides 102 comprising, for example, mirrors and/or lenses, to an optical waveguide 110. The optical guides 102 are optional in the sense that depending on the specifics of a particular embodiment, they may be absent. In other words, optical guides 102 are not present in all embodiments.

To guide light 104 into waveguide 110, an in-coupling structure, such as a partially reflecting mirror, surface relief grating or other diffractive structures may be used to direct incoming light into the waveguide 110, as is known in the art. In some embodiments, light 104 may be in-coupled from the edge of the waveguide. In waveguide 110, light 104 advances by being reflected repeatedly inside the waveguide, interacting with elements 112a until it interacts with elements 112 which cause it to be deflected from waveguide 110 to air, toward eye 120 as image-producing light rays 114. Elements 112a and 112 may comprise partially reflective mirrors, surface relief gratings or other diffractive structures, for example. Elements 112a may be arranged, for example, to spread light field 100 inside waveguide 110 such that the image of the waveguide display is correctly generated. Light from different angular parts of light field 100 will interact with elements 112 so that light rays 114 will produce the image encoded in light field 100 on the retina of eye 120. Elements 112a and elements 112 may be in part, or in whole, the same elements. In other words, in some embodiments there is a single set of elements, and in other embodiments there are two distinct sets of elements 112a, 112. Elements 112 cause the light to leave waveguide 110 at an exit location. As a consequence, the user will perceive the image encoded in light field 100 in front of his eyes 120. As waveguide 110 may be, at least in part, transparent, the user may also advantageously see his real-life surroundings through waveguide 110 in case the waveguide-based display is head-mounted, for example. Light is released from waveguide 110 in multiple angles at multiple locations at elements 112 as a consequence of the action of elements 112a and 112.

A term “color space” refers to the (two-dimensional) chromaticity diagram corresponding to the perceived colors resulting from the spectral response of an average human eye. The gamut of a device is the region of the color space, which is reproducible by that device. Specifically, here the gamut corresponds to the region in color space, which can be reproduced by the combination of light sources 140 and waveguides in the system for light fields that the observer perceives to originate from a focal plane. The Region of Interest, ROI, in turn, refers to a region of color space that is sufficient to reproduce what is perceived as a full color image, but may also correspond to a smaller or larger region of color space. As a specific point in the color space can be reached by different combinations of wavelengths, a specific ROI can be reached using different combinations of distinct spectral characteristics, such as peaks in visible spectrum.

A color image may be generated, for example by assuming the user's color vision perception corresponds to a standard eye and by reproducing (a part of) the corresponding color space. As is clear from the definition of the color space, the user perceives the same color as the result of several different light signal spectra. This provides degrees of freedom to how a waveguide 110 operates. In addition, different combinations of distinct spectral characteristics, such as wavelengths, may be used to generate the same color. How light is coupled out of the waveguide may be a function of the exit location. That is, a light ray corresponding to a specific position in the input image (specific propagation angle) may leave the waveguide at different angles depending on the exit location. In general, the user may perceive a same color from more than one spectrum of light signals 114. This yields degrees of freedom in manufacturing waveguide 110. Specifically, we note that when the ROI is chosen to lie in the intersection of the gamuts corresponding to the effective wavelengths at each separate pixel, the same color stimulus can be reproduced at each pixel. Hence modulation or filtering of the light sources on a pixel-by-pixel basis does not introduce fundamental limitations to what colors can be reproduced by the system.

In a waveguide-based display, there may be present plural waveguides 110, conveying light to increase image transmission capacity, for example, as well as, optionally, for the user's other eye which is not illustrated in FIG. 1 for the sake of clarity of the illustration.

The light field 100 encoding the image may be generated using an optical system comprising, for example, a mirror 130 and light sources R, G and B. Mirror 130 may comprise, for example, a microelectromechanical, MEMS, mirror which is configured to reflect light from light sources 140, such as lasers, as to generate the image-encoding light field 100 in a controlled manner by, for example, scanning the angular space 100 thereby generating the light field encoding the image. Mirror 130 may therefore be actuated to tilt to different angles so as to direct the light from the light sources 140 to the appropriate parts of the light field 100 in angular space. In some embodiments, the optical system may consist of other types of image generating devices, such as projectors, where the light sources may for example be LEDs and a primary display may be present in the form of a liquid crystal on silicon, LCOS, device. The optical system may, for example, comprise the light sources and MEMS actuators configured to provide light from the light sources to an angular space, thereby generating a light field for input to waveguide 110.

The system illustrated in FIG. 1 comprises three light sources 140. This is an example to which the present disclosure is not limited, rather, there may be fewer than three, or more than three, light sources. For example, in certain embodiments a monochromatic display is produced with one and only one light source. The light sources 140 may be monochromatic in the sense that they produce either a narrow spectral band of light with a single peak wavelength, as in lasers, or their spectral band may be wider, as with LEDs. Light sources with more complicated spectral distributions are also possible. In principle, the colour space that humans can see can be generated by appropriately exciting the light receptors on the retina. Typically this is achieved, by mixing three wavelengths of light, for example at one wavelength in each in the red, green and blue parts of the visible spectrum.

Laser light has a very narrow bandwidth to the extent they may be considered to be monochromatic. By monochromatic it may be meant, for example, that the bandwidth of light produced by the laser is narrower than 0.1 nanometres, or narrower than two nanometres, for example. Laser light sources may be caused to modulate their wavelength as a function of angle of the light rays corresponding to the image pixels by using a laser light source with selectable wavelength, such as, for example, an open-cavity diode laser with a piezoelectrically selectable cavity length, used in synchronized combination with mirror 130, which may be a MEMS mirror. Laser light sources may comprise one or multiple lasers. The multiple lasers may have same or different wavelength.

LED light sources have a broader wavelength range than lasers. Also LED light sources may be caused to modulate their wavelength as a function of angle. For example, they may be made monochromatic on a pixel by pixel basis by filtering with a passband filter, wherein the centre wavelength of the passband is selectable. An even better way to obtain monochromatic illumination of given pixels using LEDs is diffractively and/or refractively dispersing the light output from a LED such that a desired wavelength is directed to a given pixel. Other approaches to achieve a distribution of center wavelengths across the pixels are of course also possible. The crux is that this can, specifically, be done in such a way that there is correspondence between the angle of propagation of the light ray representing the pixel inside the waveguide and its (center) wavelength. Furthermore, this correspondence can be made to (closely) match the shift of the filtered wavelength bands, with respect to the angle of incidence, that typically occurs in notch filters. The LED light sources may be used in an LCOS implementation. Alternatively or additionally, lasers and suitable optics may be used instead of LED light sources. In general, a notch filter may have a stopband with a width of at most two nanometres or at most three nanometres, for example.

To produce a colour image encoded in the light field in angular space 100, light source(s) 140 may, for example, be programmatically controlled. In instances where the mirror 130 is present, light source(s) 140 and the mirror 130 may be synchronized with each other such that light from light source(s) 140 illuminate specific angular regions of light field 100 in a controlled manner so as to produce therein a representation of a colour image which reproduces a still or moving input image received from an external source, such as, for example, a virtual reality or augmented reality computer. The still or moving image received from the external source may comprise a digital image or a digital video feed, for example. The image encoded in light field 100 is thus configurable by provision of a suitably selected input image.

To produce a specific colour at a given aspect in angular space 100, this given aspect in angular space 100 may be illuminated by one or more light sources 140, for example a set of three or more light sources 140. This specific colour is then reproduced by the light rays 114, as light from the given aspect in angular space 100 proceeds in waveguide 110 to an element 112, where it exits at an angle corresponding to the given aspect in angular space 100.

Light leakage through outer surface 202 of the waveguide display is unwanted, as it reduces the brightness of the image the user sees and alerts other persons to the fact that an image is displayed. Furthermore, the leaked light may flicker annoyingly or even reveal the contents of the image itself. In an optimum case, light would only leave waveguide 110 in a controlled manner through inner surface 201 of waveguide 110. To alleviate light leakage through the outer surface 202, a notch filter element 200 is attached on outer surface 202. The notch filter element may be a diffracting grating or may consist of a mostly transparent film, which includes a notch filter designed to prevent light of wavelength(s) matching the light source(s) 140 from passing through, while admitting other wavelengths through. Thus, the user can see through waveguide 110, but leakage of specifically light from light sources 140 is reduced. Notch filters may be realized, for example, as stacks of thin homogeneous (dielectric) layers, where filter characteristics are determined by the number of layers, thicknesses of each layer and the materials of the layers. Typical layer materials include SiO2 and TiO2. In general, a dielectric filter is a reflecting filter. To construct an absorbing filter absorbing materials, such as metals, are required.

In general, as an image conveyed via waveguide 110 consists of a set of narrow wavelength bands (or even a single narrow wavelength band), blocking it using one or more notch filters only involves a small part of the visible spectrum, wherefore visibility for the user through waveguide 110 is barely impacted. This is so, since a light field the user sees around him comprises a broad wavelength range of visible light. The notch filter(s) thus have a minimal effect on the information content of light the user sees from around him. The notch filters in waveguide 110 may reflect the light not allowed through, as reflective filters provide the technical benefit of conserving light power in the waveguide. A separate absorbing notch filter structure may be placed on the outside surface of the filter element 200, to attenuate a mirror-like effect of the waveguide reflective notch filters might create for people around the user. There are therefore four options to arrange the notch filters: firstly, a purely absorptive notch filter, secondly, a purely reflective notch filter, thirdly, a reflective notch filter facing the user with an absorptive notch filter covering the reflective notch filter on the outside, and fourthly a diffracting notch filter, whose behaviour may depend on the side from which light is incident upon it, thus being the most general choice.

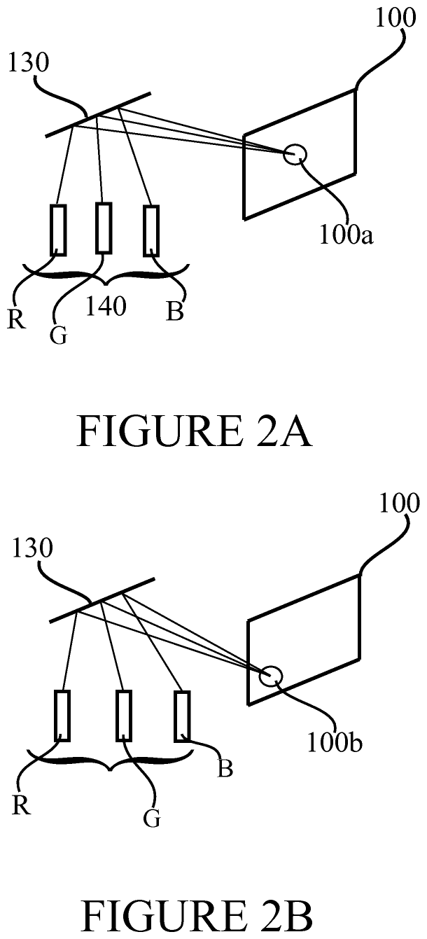

FIGS. 2A and 2B illustrate an example system in accordance with at least some embodiments of the present invention. Like numbering denotes like structure as in FIG. 1. In FIG. 2A, the three light sources 140 are separately identified as light source B, light source G and light source R. For example, light source B may be in the blue part of visible spectrum, light source G may be in the green part of visible spectrum and light source R may be in the red part of visible spectrum. In general, the light sources may be in the visible part of spectrum.

In FIG. 2A, light sources B, G and R are used to produce a specific colour in angular part 100a of light field 100. The specific colour is determined by the relative powers of the light sources B, G and R, and the brightness of the colour is determined by the sum of powers of these light sources.

Proceeding then to FIG. 2B, light sources B, G and R are used to produce the specific colour, for example the same colour as in FIG. 2A in angular part 100b of light field 100. Angular part 100b is in a different angular part of the light field from where angular part 100a is. The specific colour is determined by the relative powers of the light sources B, G and R, and the brightness of the colour is determined by the sum of powers of these light sources. Light advancing in waveguide 110 to angular part 100a may be reflected inside waveguide 110 at different angles than light advancing to angular part 100b.

A feature of notch filters, for example notch filters in thin films, is that the notch frequency, which the filter blocks, may exhibit a dependency on the angle of incident radiation. In other words, the wavelength blocked by the notch filter may not be a constant function of the incident angle. Therefore, the capacity to filter a specific wavelength may degrade away from the central/design wavelength. The centre wavelength of a notch of a notch filter is this not strictly constant, but depends on the angle of incidence. The centre wavelength of the notch may be expressed in terms of the centre wavelength when light is incident on a specific, first, angel of incidence. In at least some embodiments of the invention, this is compensated by shifting the wavelength(s) of the light source(s) as a function of the angle.

Light sources 140 may consequently be controlled in such a manner, as to pre-correct the incident-angle variability of notch filters used, such that the light is effectively blocked by the notch filters in different parts of waveguide 110. When encoding a still or video image into the angular space of light field 100, the angular parts of light field 100 may be scanned in a continuous manner, such that aspects of light field 100 are scanned using differently adjusted light source frequencies during the continuous scanning. By continuous scanning it is herein meant a repeating process of causing colour elements to be rendered into light field 100. Thus, the combination of monochromatic light sources used in combination with notch filters as described herein provides the benefit that private light information of the user does not leak out, and simultaneously the user's ability to see his surroundings through the waveguide display is not compromised.

In the embodiment of FIG. 1 waveguide 110, having a first, inner surface 201 close to the eye of the user and a second, outer surface 202 on the opposite side of the waveguide 110 has a notch filter element 200 on the second, outer surface 202 in order to prevent the light from light field 100 from being visible to others than the user of the waveguide display.

The notch filter element 200 may be a multi-layer structure designed to function as a band stop filter for each of the light sources 140, R, G and B. In one example, the notch filter element 200 is formed as a sandwich structure of three different notch filters. As another example, a single layer comprises multiple notches.

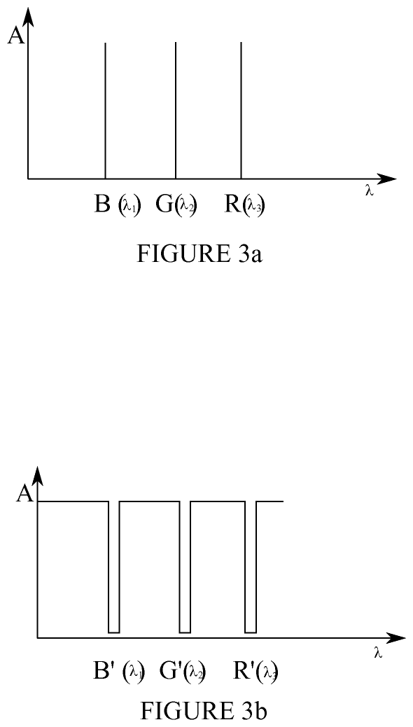

In FIG. 3a is presented a graph of the wavelengths of the light sources B, G and R, where x-axis represents wavelength and y-axis amplitude. As presented in the picture, light source B has a wavelength λ₁, light source G wavelength λ₂ and light source R wavelength λ₃ correspondingly. The light sources in this example are monochromatic, for example lasers.

In FIG. 3b is presented a graph of the transmittance of notch filter element 200 for the light sources of FIG. 3a. As indicated in the graph, each stop-band G′, B′ and R′ of the filter has the same center wavelength as the light sources G, B and R. In practice the angle of incidence of the light inside waveguide 110 into the notch filter 200 alters the filtering properties of the notch filter 200, and therefore there might be a need for adjustment of the wavelength of light entering the notch filter element 200 in different angles. This could be made, for example, by wavelength modulation and/or adjustment of light source(s) 140 such that the wavelength of the light sources is modulated and/or adjusted based on the angle of incidence of the light in the waveguide 110 incident onto notch filter element 200, or based on the angle of incidence to the waveguide 110, which may be interrelated. In some embodiments, the notch filter may have multiple stop-bands corresponding to single light source to account for different propagation directions inside the waveguide. For example, stop-band G′ may comprise multiple stop-band for source G to account for multiple propagation directions. The multiple propagation directions of light originating from a single source may be due to diffraction to multiple diffraction orders, for example. An alternative or additional solution could be to widen the stop-bands R′, G′ and B′ of notch filter element 200, however this solution would decrease the overall transmittance of the notch filter element 200.

In the examples of FIGS. 3a and 3b, three sources and corresponding three stop-bands are considered. In a more general case, the number and locations of stop-bands correspond to the spectral characteristics of the one or more light sources used in an embodiment. For example, in an arrangement with two sources having distinct wavelengths, a notch filter with two stop-bands corresponding to the two distinct wavelengths may be used.

Teachings how to design optical notch filters can be found e.g. from the following web page: https://www.optilayer.com/notch-filters. The use of optical notch filters is also presented in EP-patent application 15812618.5.

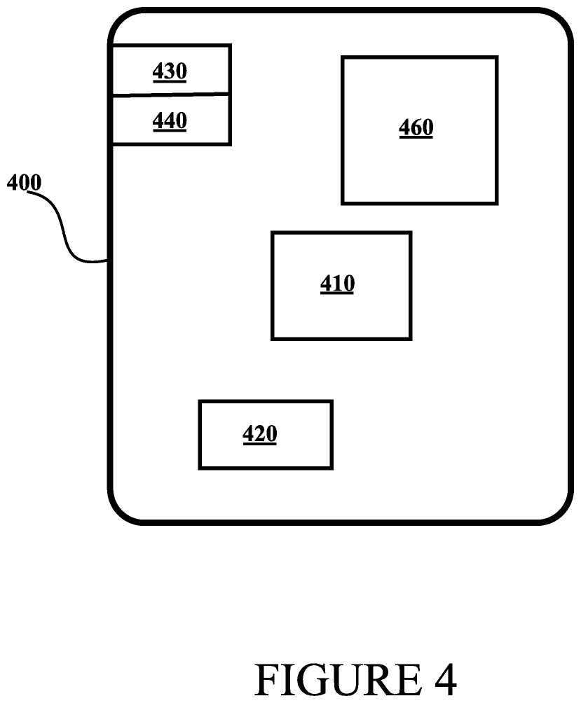

Overall, therefore, the wavelengths of light sources 140, such as lasers, may be modulated during the production of light field 100, to cause the light in waveguide 110 to be matched with the stop-bands of notches of notch filter element 200 regardless of its angle of incidence on notch filter element 200 in the waveguide. Or, the modulating may at least increase the effectiveness of notch filter element 200 in filtering leaked light, even if all of the leaked light is not caught. Such modulating may comprise adjusting the wavelengths of the light sources according to a mapping which maps angular parts of the light field with wavelength adjustments. The mapping may be experimentally determined in advance, for example, since the way the notches move as a function of the angle of incidence is deterministic. The mapping may be stored in a memory of a computer such as the one illustrated in FIG. 4, which is configured to control the encoding of the image in light field 100. Using LED light sources, a passive control mechanism may be used based on for example diffractive or refractive splitting of the LED output wavelength band, as described herein above. In an extreme case, a filter with passband of same width as the stopband in the notch filters could be used to render LED output monochromatic. Other light source modulation and light source filtering techniques can also be used to achieve the desired correspondence between propagation angle and (center) wavelength.

FIG. 4 illustrates an example apparatus capable of supporting at least some embodiments of the present invention. Illustrated is device 400, which may comprise, for example, a control mechanism for operating an arrangement such as one illustrated in FIG. 1 or FIG. 2. Comprised in device 400 is processor 410, which may comprise, for example, a single- or multi-core processor or microcontroller wherein a single-core processor comprises one processing core and a multi-core processor comprises more than one processing core. Processor 410 may comprise, in general, a control device. Processor 410 may comprise more than one processor. Processor 410 may be a control device. A processing core may comprise, for example, a Cortex-A8 processing core manufactured by ARM Holdings or a Steamroller processing core designed by Advanced Micro Devices Corporation. Processor 410 may comprise at least one Qualcomm Snapdragon and/or Intel Atom processor. Processor 410 may comprise at least one application-specific integrated circuit, ASIC. Processor 410 may comprise at least one field-programmable gate array, FPGA. Processor 410 may be means for performing method steps in device 400, such as generating, receiving and conveying. Processor 410 may be configured, at least in part by computer instructions, to perform actions.

Device 400 may comprise memory 420. Memory 420 may comprise random-access memory and/or permanent memory. Memory 420 may comprise at least one RAM chip. Memory 420 may comprise solid-state, magnetic, optical and/or holographic memory, for example. Memory 420 may be at least in part accessible to processor 410. Memory 420 may be at least in part comprised in processor 410. Memory 420 may be means for storing information. Memory 420 may comprise computer instructions that processor 410 is configured to execute. When computer instructions configured to cause processor 410 to perform certain actions are stored in memory 420, and device 400 overall is configured to run under the direction of processor 410 using computer instructions from memory 420, processor 410 and/or its at least one processing core may be considered to be configured to perform said certain actions. Memory 420 may be at least in part comprised in processor 410. Memory 420 may be at least in part external to device 400 but accessible to device 400. Memory 420 may store information defining angular parts of light field 100, for example.

Device 400 may comprise a transmitter 430. Device 400 may comprise a receiver 440. Transmitter 430 and receiver 440 may be configured to transmit and receive, respectively, information in accordance with at least one cellular or non-cellular standard. Transmitter 430 may comprise more than one transmitter. Receiver 440 may comprise more than one receiver. Receiver 440 may be configured to receive an input image, and transmitter 430 may be configured to output control commands to direct mirror 130, where present, and light sources 140, for example, in accordance with the input image.

Device 400 may comprise user interface, UI, 460. UI 460 may comprise at least one of a display, a keyboard, a touchscreen, a vibrator arranged to signal to a user by causing device 400 to vibrate, a speaker and a microphone. A user may be able to operate device 400 via UI 460, for example to configure display parameters.

Processor 410 may be furnished with a transmitter arranged to output information from processor 410, via electrical leads internal to device 400, to other devices comprised in device 400. Such a transmitter may comprise a serial bus transmitter arranged to, for example, output information via at least one electrical lead to memory 420 for storage therein. Alternatively to a serial bus, the transmitter may comprise a parallel bus transmitter. Likewise processor 410 may comprise a receiver arranged to receive information in processor 410, via electrical leads internal to device 400, from other devices comprised in device 400. Such a receiver may comprise a serial bus receiver arranged to, for example, receive information via at least one electrical lead from receiver 440 for processing in processor 410. Alternatively to a serial bus, the receiver may comprise a parallel bus receiver.

Device 400 may comprise further devices not illustrated in FIG. 4. In some embodiments, device 400 lacks at least one device described above. For example, some devices 400 may lack a user interface 460.

Processor 410, memory 420, transmitter 430, receiver 440, NFC transceiver 450, UI 460 and/or user identity module 470 may be interconnected by electrical leads internal to device 400 in a multitude of different ways. For example, each of the aforementioned devices may be separately connected to a master bus internal to device 400, to allow for the devices to exchange information. However, as the skilled person will appreciate, this is only one example and depending on the embodiment various ways of interconnecting at least two of the aforementioned devices may be selected without departing from the scope of the present invention.

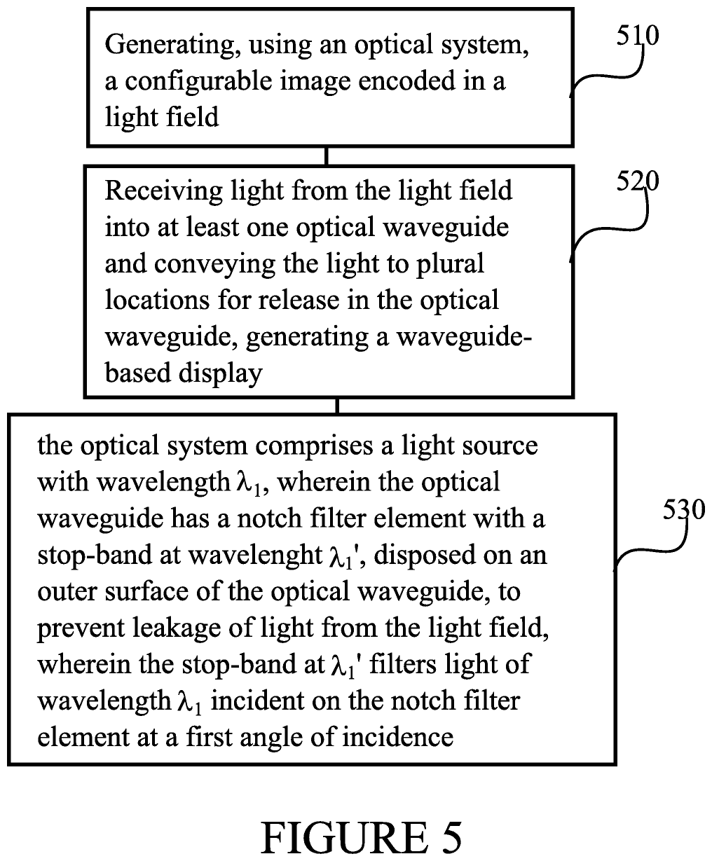

FIG. 5 is a flow graph of a method in accordance with at least some embodiments of the present invention. The phases of the illustrated method may be a waveguide based display, an optical waveguide arrangement in or for a waveguide based display, or in a control mechanism configured to control the functioning thereof, when installed therein.

Phase 510 comprises generating, using an optical system, a configurable image encoded in a light field. Phase 520 comprises receiving light from the light field into at least one optical waveguide and conveying the light to plural locations in the optical waveguide for release, generating a waveguide-based display. Phase 530 specifies that the optical system comprises three light sources with wavelengths λ₁, λ₂, and λ₃, respectively, wherein the optical waveguide has a notch filter element with stop-bands at wavelengths λ₁′, λ₂′, and λ₃′ disposed on an outer surface of the optical waveguide to prevent leakage of light from the light field. As explained before, λ₁ and λ₁′ may not be equal in a general case. Instead, the notch-filter comprising stop-band at λ₁′ may be designed to stop light with wavelength λ₁ incident at particular angle. For example, stop-band at λ₁′ may correspond to light with wavelength λ₁ incident with an angle corresponding to a central pixel. In case of illuminating a pixel with different incidence angle, the wavelength of the source λ₁ may be adjusted such that the stop-band at λ₁′ stops that light also. The same applies respectively to each light source and a corresponding stop-band of the notch-filter, i.e., stop-bands at λ₂′, λ₃′ and correspond to light sources with wavelengths λ₂, and λ₃ in phase 530 of FIG. 5.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in enhancing waveguide displays.

### ACRONYMS LIST

LED light emitting diode
MEME microelectromechanical

### REFERENCE SIGNS LIST

| | |
|---|---|
| 100 | light field |
| 102 | optical guides |
| 104 | Light |
| 110 | Waveguide |
| 112a, 112 | Elements |
| 114 | directed light |
| 120 | eye(s) |
| 130 | Mirror |
| 140 | light sources |
| 100a, 100b | angular part of light field 100 |
| 400-460 | structure of the apparatus of FIG. 4 |
| 410-430 | phases of the method of FIG. 4 |
| 200 | notch filter element |
| 201 | first (inner) surface of the waveguide |
| 202 | second (outer) surface of the waveguide |
| R | light source with wavelength λ₁ |
| G | light source with wavelength λ₂ |
| B | light source with wavelength λ₃ |
| R′ | stop-band of notch filter with wavelength λ₁ |
| G′ | stop-band of notch filter with wavelength λ₂ |
| B′ | stop-band of notch filter with wavelength λ₃ |
| λ₁₋₃ | centre wavelengths of light sources and stop-bands |

1. An optical waveguide arrangement comprising:
an optical system configured to generate a configurable image encoded in a light field;
at least one optical waveguide, arranged to receive light from the light field and to convey the light to plural locations in the optical waveguide for release, generating a waveguide-based display,
the optical system comprises a light source with wavelength λ₁, wherein
the optical waveguide, comprises a notch filter element with a stop-band at wavelength λ₁′, disposed on an outer surface of the optical waveguide to prevent leakage of light from the light field, wherein the stop-band at wavelength λ₁′ filters light of wavelength λ₁ incident on the notch filter element at a first angle of incidence,
wherein the optical waveguide arrangement is configured to modulate the wavelength of the light source based on an angle of incidence of the light in the waveguide onto the notch filter element and/or based on an angle of incidence of the light to the waveguide.

2. The optical waveguide arrangement according to claim 1, wherein the optical system further comprises a light source with wavelength λ₂, and wherein the notch filter element further has a stop-band at wavelength λ₂′, wherein the stop-band at wavelength λ₂′ filters light of wavelengths λ₂, incident on the notch filter element at the first, or a second, angle of incidence.

3. The optical waveguide arrangement according to claim 2, wherein the optical system further comprises a light source with wavelength λ₃, and wherein the notch filter element has a stop-band at wavelength λ₃′, wherein the stop-band at wavelength λ₃′ filters light of wavelength λ₃, incident on the notch filter element at the first angle, the second angle, or a third angle of incidence.

4. The optical waveguide arrangement according to claim 1, wherein the modulating comprises adjusting the wavelengths of the light sources according to a mapping of an angular part of light field to a stop-band of the notch-filter.

5. The optical waveguide arrangement according to claim 2, wherein the light sources comprise laser light sources.

6. The optical waveguide arrangement according to claim 2, wherein the light sources comprise light emitting diode light sources.

7. The optical waveguide arrangement according to claim 1, wherein the optical waveguide arrangement is configured to provide the display as a head-mounted display.

8. The optical waveguide arrangement according to claim 2, wherein the notch filter stopbands have widths of at most 2 nanometres.

9. The optical waveguide arrangement according to claim 2, wherein the notch filters are reflective notch filters.

10. The optical waveguide arrangement according to claim 1, wherein the notch filter stopband has a width of at most 2 nanometres.

11. The optical waveguide arrangement according to claim 1, wherein the notch filter is a reflective notch filter.

12. The optical waveguide arrangement according to claim 1, wherein the notch filter element is configured with more than one stop-band for each light source in the optical waveguide arrangement.

13. A method, comprising operating an optical waveguide arrangement comprising:
generating, using an optical system, a configurable image encoded in a light field;
receiving light from the light field into at least one optical waveguide and conveying the light to plural locations in the optical waveguide for release, generating a waveguide-based display, wherein
the optical system comprises a light source with wavelength λ₁, wherein
the optical waveguide, has a notch filter element with a stop-band at wavelength λ₁′, disposed on an outer surface of the optical waveguide to prevent leakage of light from the light field, wherein the stop-band at wavelength λ₁′ filters light of wavelength λ₁ incident on the notch filter element at a first angle of incidence,
wherein the method further comprises modulating the wavelength of the light source based on an angle of incidence of the light in the waveguide onto the notch filter element and/or based on an angle of incidence of the light to the waveguide.

14. The method according to claim 13, wherein the optical system further comprises a light source with wavelength λ₂, and wherein the notch filter element further has a stop-band at wavelength λ₂′, wherein the stop-band at wavelength λ₂′ filters light of wavelengths λ₂, incident on the notch filter element at the first, or a second, angle of incidence.

15. The method according to claim 14, wherein the optical system further comprises a light source with wavelength λ₃, and wherein the notch filter element has a stop-band at wavelength λ₃′, wherein the stop-band at wavelength λ₃′ filters light of wavelength λ₃, incident on the notch filter element at the first angle, the second angle, or a third angle of incidence.

16. The method according to claim 13, wherein the modulating comprises adjusting the wavelength of the light source according to a mapping which maps angular parts of the light field with wavelength adjustments.

17. The method according to claim 14, wherein the light sources comprise laser light sources.

18. The method according to claim 14, wherein the light sources comprise light emitting diode light sources.

19. The method according to claim 13, wherein the operating comprises providing the display as a head-mounted display.

20. A non-transitory computer readable medium having stored thereon a set of computer readable instructions that, when executed by at least one processor, cause an apparatus to at least:
generate, using an optical system, a configurable image encoded in a light field;
convey light from the light field into at least one optical waveguide which is arranged to receive and to convey the light to plural locations in the optical waveguide for release, generating a waveguide-based display,
the optical system comprising a light source with wavelength λ₁, wherein
the optical waveguide has a notch filter element with a stop-band at wavelength λ₁′, disposed on an outer surface of the optical waveguide to prevent leakage of light from the light field, wherein the stop-band at wavelength λ₁′ filters light of wavelength λ₁ incident on the notch filter element at a first angle of incidence, and
wherein the computer readable instructions are further configured to cause the apparatus to modulate the wavelength of the light source based on an angle of incidence of the light in the waveguide onto the notch filter element and/or based on an angle of incidence of the light to the waveguide.

21. A computer program configured to cause a method in accordance with claim 13 to be performed.
